(19) United States
(12) Patent Application Publication
(10) Pub. No.: US 2025/0304805 A1
(43) Pub. Date: Oct. 2, 2025

(54) PEELING LIQUID COMPOSITION AND METHOD FOR PRODUCING RECYCLED ALUMINUM SUBSTRATE

(71) Applicant: FUJIFILM Business Innovation Corp., Tokyo (JP)

(72) Inventor: Akihiro KAWASAKI, Kanagawa (JP)

(73) Assignee: FUJIFILM Business Innovation Corp., Tokyo (JP)

(21) Appl. No.: 18/796,487

(22) Filed: Aug. 7, 2024

(30) Foreign Application Priority Data
Mar. 27, 2024 (JP) 2024-052547

(51) Int. Cl. C09D 9/00

(52) U.S. Cl. CPC C09D 9/005

(57) ABSTRACT

A peeling liquid composition includes an aromatic alcohol, a compatibilizer, water, alkanolamine, and an anionic surfactant, and the content A of the aromatic alcohol, the content B of the compatibilizer, and the content C of water satisfy formula 1 and formula 2 below:

$$X \geq 0. 6 \qquad Formula 1$$

$$C \leq ( - 1.80 \times {X}^{2} + 1.05 \times X + 0.72 ) \times 100 \qquad Formula 2$$

in the formula 1 and formula 2, X represents the ratio (A/(A+B)) of the content A to the total of the content A of the aromatic alcohol and the content B of the compatibilizer.

### CROSS-REFERENCE TO RELATED APPLICATIONS

This application is based on and claims priority under 35 USC 119 from Japanese Patent Application No. 2024-052547 filed Mar. 27, 2024.

### BACKGROUND

### (i) Technical Field

The present disclosure relates to a peeling liquid composition and a method for producing a recycled aluminum substrate.

### (ii) Related Art

In an image forming apparatus (a copying machine, a facsimile, a printer, or the like) using an electrophotographic system, a toner image formed on the surface of an image holding member, such as a photoreceptor or the like, is transferred to the surface of a recording medium and fixed to the recording member, forming an image. A photoreceptor having a configuration including a resin layer on a metal substrate is used as the photoreceptor. From the viewpoint of recycling the substrate in the photoreceptor, investigation is performed on a method for peeling the resin layer on the substrate.

For example, Japanese Unexamined Patent Application Publication No. 2010-044169 discloses a technique in which a photoreceptor including a photosensitive layer containing a resin component on a conductive support is dipped in a peeling liquid having a composition containing a dibasic acid ester, a peeling accelerator, and a reducing electrolyzed water, fluid power is applied to the peeling liquid to peel the photosensitive layer from the surface of the support by the fluid power of the peeling liquid while uniformly mixing the peeling liquid, washing the support, from which the photosensitive layer is peeled, with the reducing electrolyzed water to obtain a recycled support, and again forming a photosensitive layer on the recycled support to form a new photoreceptor.

Japanese Unexamined Patent Application Publication No. 2010-160394 discloses a method for peeling a layer of an electrophotographic photoreceptor having a layer configuration in which at least an intermediate layer, a charge generating layer, and a charge transport layer containing a binder resin are sequentially laminated on a conductive substrate, the method including dipping the electrophotographic photoreceptor in a peeling liquid which swells the binder resin of the charge transport layer but not dissolve the resin, and swelling and peeling the charge transport layer by supplying compressed gas to the peeling liquid.

International Publication No. 2009/051237 discloses a peeling liquid composition containing an alkanol amine, an aromatic alcohol, and an anticorrosive agent.

Japanese Unexamined Patent Application Publication No. 2015-129231 discloses a stripping agent for stripping a coating film provided on a surface of a metal substrate, the stripping agent comprising a compound having an amide group, an alkanolamine, and an aromatic alcohol.

### SUMMARY

Aspects of non-limiting embodiments of the present disclosure relate to a peeling liquid composition capable of satisfactorily peeling a urethane resin layer while suppressing damage to the surface of an aluminum substrate when the urethane resin layer in contact with the surface of the aluminum substrate is peeled, and also relate to a method for producing a recycled aluminum substrate, which may satisfactorily peel a urethane resin layer while suppressing damage to the surface of an aluminum substrate.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a peeling liquid composition including an aromatic alcohol, a compatibilizer, water, an alkanolamine, and an anionic surfactant,
wherein the content A of the aromatic alcohol, the content B of the compatibilizer, and the content C of water satisfy formula 1 and formula 2 below,

$$X \geq 0. 6 \qquad Formula 1$$

$$C \leq ( - 1.80 \times {X}^{2} + 1.05 \times X + 0.72 ) \times 100 \qquad Formula 2$$

in the formula 1 and formula 2, X represents the ratio (A/(A+B)) of the content A to the total of the content A of the aromatic alcohol and the content B of the compatibilizer.

### DETAILED DESCRIPTION

An exemplary embodiment of the present disclosure is described below. The description and examples exemplify the embodiment and do not limit the scope of the embodiment.

In the numerical ranges stepwisely described in the present exemplary embodiment, the upper liquid value or lower limit value described in one of the numerical ranges may be replaced by the upper limit value or the lower limit value of another numerical range stepwisely described. Also, in a numerical range described in the exemplary embodiment, the upper limit value or lower limit value of the numerical range may be replaced by the value described in an example.

In the exemplary embodiment, the term “process” includes not only an independent process but also even a process which cannot be clearly discriminated from another process if the intended purpose of the process can be achieved.

In the exemplary embodiment, when the exemplary embodiment is described with reference to drawings, the configuration of the exemplary embodiment is not limited to the configuration shown in the drawings. In addition, in each of the drawings, the size of a member is conceptual, and the relative relationship between the sizes of members is not limited to that shown in the drawings.

In the exemplary embodiment, each of the components may contain plural materials corresponding to the component. In the description of the amount of each of the components in a composition, when plural materials corresponding each of the components are present in the composition, the amount represents the total amount of the plural materials present in the composition unless otherwise specified.

### [Peeling Liquid Composition]

A peeling liquid composition according to the exemplary embodiment includes an aromatic alcohol, a compatibilizer, water, an alkanolamine, and an anionic surfactant. The content A of the aromatic alcohol, the content B of the compatibilizer, and the content C of water satisfy formula 1 and formula 2 below.

$$X \geq 0. 6 \qquad Formula 1$$

$$C \leq ( - 1.80 \times {X}^{2} + 1.05 \times X + 0.72 ) \times 100 \qquad Formula 2$$

In the formula 1 and formula 2, X represents the ratio (A/(A+B)) of the content A to the total of the content A of the aromatic alcohol and the content B of the compatibilizer.

In addition, the content A of the aromatic alcohol, the content B of the compatibilizer, and the content C of water each represent the content (% by mass) in the peeling liquid composition.

The peeling liquid composition according to the exemplary embodiment has the configuration described above and thus may satisfactorily peel a urethane resin layer while suppressing damage to the surface of an aluminum substrate when the urethane resin layer in contact with the surface of the aluminum substrate is peeled. The reason for this is supposed as follows.

In a metal-resin composite having a urethane resin layer in contact with the surface of an aluminum substrate, it is difficult to peel the crosslinked urethane resin layer from the substrate. A conceivable method includes peeling by physically applying strong force, but the method has difficulty in satisfactorily peeling the urethane resin layer while suppressing damage to the surface of the aluminum substrate.

On the other hand, the peeling liquid composition according to the exemplary embodiment has the configuration described above.

Among the components contained in the peeling liquid composition, the alkanolamine contributes to bond breakage by attacking a bond portion in the urethane resin. Also, the aromatic alcohol permeates into the urethane resin and swells the urethane resin while suppressing recombination of the broken bond portion of the urethane resin, thereby contributing to peeling of the urethan resin layer from the aluminum substrate. In addition, the anionic surfactant adsorbs on the surface of the aluminum substrate and protects the surface, thereby contributing to the suppression of damage to the surface of the substrate. In addition, the presence of water causes the anionic surfactant to satisfactorily adsorb to the surface of the aluminum substrate due to satisfactory function of the anionic surfactant. Also, the presence of the compatibilizer makes the aromatic alcohol satisfactorily compatible with water, and thus the effect described above is satisfactorily exhibited.

In addition, the ratio (A/(A+B)) between the content A of the aromatic alcohol and the content B of the compatibilizer satisfies the formula 1 (that is, 0.6 or more), and thus a sufficient amount of the aromatic alcohol is contained, thereby satisfactorily exhibiting the effect of the aromatic alcohol described above.

Further, the formula 2, which is the relational expression between the ratio (A/(A+B)) between the content A of the aromatic alcohol and the content B of the compatibilizer and the content C of water, is satisfied, and this becomes an index indicating that each of the components in the peeling liquid composition is dissolved. When the formula 2 is not satisfied, the components are separately present in the peeling liquid composition, and thus the effect of each of the components is not satisfactorily exhibited. When the peeling liquid composition satisfies the formula 2, the components are present in a dissolved state in the peeling liquid composition, and thus the effect of each of the components described above is satisfactorily exhibited.

As described above, the peeling liquid composition according to the exemplary embodiment may satisfactorily peel the urethane resin layer while suppressing damage to the surface of the aluminum substrate when the urethane resin layer in contact with the surface of the aluminum substrate is peeled.

### Aromatic Alcohol

Examples of the aromatic alcohol include benzyl alcohol, 2-phenylethanol, 2-aminobenzyl alcohol, 3-aminobenzyl alcohol, 2,3-dimethoxybenzyl alcohol, 1-naphthalenemethanol, furfuryl alcohol, 2-pyridinemethanol, 4-pyridinemethanol, and the like.

From the viewpoint of satisfactorily peeling the urethane resin layer, the peeling liquid composition preferably contains as the aromatic alcohol at least one selected from the group consisting of benzyl alcohol, 2-phenylethanol, 2-aminobenzyl alcohol, 3-aminobenzyl alcohol, and 2,3-dimethoxybenzyl alcohol. Further, the peeling liquid composition more preferably contains benzyl alcohol as the aromatic alcohol.

[Chem. 1]

| | |
|---|---|
| Benzyl alcohol | |
| 2-Phenylethanol | |
| 2-Aminobenzyl alcohol | |
| 3-Aminobenzyl alcohol | |
| 2,3-Dimethoxybenzyl alcohol | 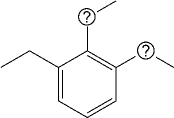 |

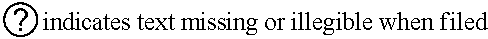

From the viewpoint of satisfactorily peeling the urethane resin layer, the content of the aromatic alcohol in the peeling liquid composition is preferably 30% by mass or more and 65% by mass or less and more preferably 35% by mass or more and 60% by mass or less.

### Compatibilizer

The compatibilizer is used as a material having good compatibility with the aromatic alcohol and water and allowing the aromatic alcohol, having low solubility in water, to be dissolved in water. Examples thereof include sodium benzenesulfonates, sodium aromatic carboxylates, glycol ethers, and the like.

Examples of sodium aromatic carboxylates include sodium benzoate, sodium salicylate, and the like.

Examples of glycol ethers include ethylene glycol monomethyl ether, ethylene glycol monoethyl ether, ethylene glycol dimethyl ether, diethylene glycol dimethyl ether, and the like.

From the viewpoint of satisfactorily peeling the urethane resin layer, the compatibilizer is preferably sodium benzenesulfonate.

From the viewpoint of satisfactorily peeling the urethane resin layer, the peeling liquid composition preferably contains, as sodium benzenesulfonate, at least one the group including sodium 2,4-dimethylbezenesulfonate, sodium 3,5-dimethylbenzenesulfonte, sodium 4-dodecylbenzenesulfonate, sodium cumenesulfonate, and sodium o-formylbenzenesulfonate. Further, the peeling liquid composition more preferably contains as sodium benzenesulfonate sodium 2,4-dimethylbenzenesulfonate.

[Chem. 2]

| | |
|---|---|
| Sodium 2,4-dimethylbenzenesulfonate | 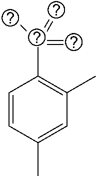 |
| Sodium 3,5-dimethylbenzenesulfonate | 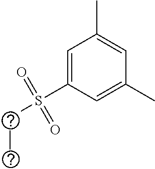 |
| Sodium 4-dodecylbenzenesulfonate | 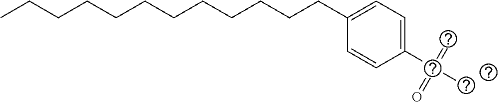 |
| Sodium cumenesulfonate | 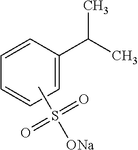 |
| Sodium o-formylbenzenesulfonate | 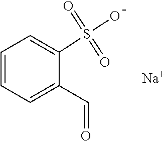 [SMILES: O=Cc1ccccc1S(=O)(=O)O ; [Na+]] |

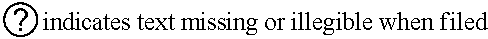

From the viewpoint of satisfactorily peeling the urethane resin layer, the content of the compatibilizer in the peeling liquid composition is preferably 10% by mass or more and 35% by mass or less and more preferably 12% by mass or more and 30% by mass or less.

### Water

From the viewpoint of suppressing damage to the surface of the aluminum substrate, the content of the water in the peeling liquid composition is preferably 10% by mass or more and 40% by mass or less, more preferably 15% by mass or more and 35% by mass or less, and still more preferably 20% by mass or more and 30% by mass or less.

### Alkanolamine

Examples of the alkanolamine include ethanolamine, diethanolamine, triethanolamine, isopropanolamine, triisopropanolamine, aminoethylethanolamine, 2-amino-2-methyl-1-propanol, diglycolamine, N-methyl-2-pyrrolidone, N-methylethanolamine, N-methyldiethanolamine, polyetheramine, and the like.

From the viewpoint of satisfactorily peeing the urethane resin layer, the peeling liquid composition preferably 6 contains as the alkanolamine at least one selected from the group including ethanolamine, diethanolamine, triethanolamine, isopropanolamine, triisopropanolamine, aminoethylethanolamine, 2-amino-2-methyl-1-propanol, diglycolamine, and N-methyl-2-pyrrolidone. Further, the peeling liquid composition more preferably 6 contains as the alkanolamine at least one selected from the group including diethanolamine, and isopropanolamine.

[Chem. 3]

| | |
|---|---|
| Ethanolamine | 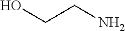 |
| Diethanolamine | 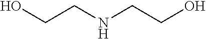 |
| Triethanolamine | 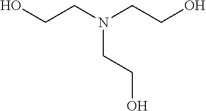 |
| Isopropanolamine | 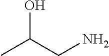 |
| Isopropanolamine | 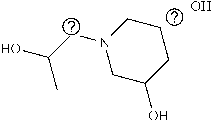 |
| Aminoethylethanolamine | 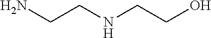 |
| 2-Amino-2-methyl-1-propanol . | 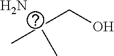 |
| Diglycolamine | 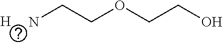 |
| N-methyl-2-pyrrolidone | 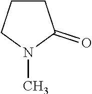 |

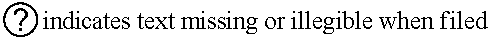

From the viewpoint of satisfactorily peeling the urethane resin layer, the content of the alkanolamine in the peeling liquid composition is preferably 0.5% by mass or more and 10% by mass or less, more preferably 1% by mass or more and 5% by mass or less, and still more preferably 2% by mass or more and 4% by mass or less.

### Anionic Surfactant

Examples of the anionic surfactant include a succinic acid-type anionic surfactant, a phosphate ester-type anionic surfactant, and the like.

In addition, a succinic acid-type anionic surfactant and a phosphate ester-type surfactant are preferably contained as the anionic surfactant.

White pitting corrosion and blackening of the surface of the aluminum substrate are suppressed by containing both anionic surfactants. The white pitting corrosion represents a phenomenon that holes are formed and discolored into white in the surface of the aluminum substrate and is also referred to as “white rust”. The blackening represents a phenomenon that the surface of the aluminum substrate is discolored into black and loses glossiness and is also referred to as “charring”.

The white pitting corrosion is supposed to be suppressed by adsorption of the surfactant to the surface of the aluminum substrate and protecting the surface from an alkali aqueous solution. On the other hand, blackening is supposed to be suppressed due to proceeding of corrosion in a nearly uniform state of the surface of the aluminum substrate by the effect of an alkaline environment and two polar groups.

[Chem. 4]

| | |
|---|---|
| Succinic acid-type anionic surfactant | 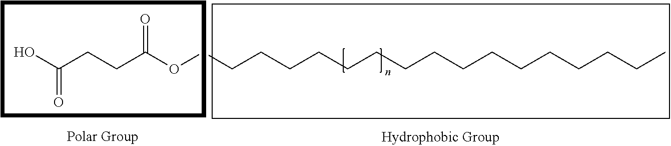 |
| Phosphate ester-type anionic surfactant | 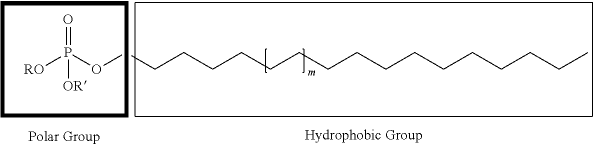 |

From the viewpoint of suppressing damage to the surface of the aluminum substrate, the content of the anionic surfactant in the peeling liquid composition is preferably 1% by mass or more and 10% by mass or less and more preferably 3% by mass or more and 9% by mass or less.

When both the succinic acid-type anionic surfactant and the phosphate ester-type anionic surfactant are contained, the content of the succinic acid-type anionic surfactant is preferably 1% by mass or more and 10% by mass or less and more preferably 3% by mass or more and 7% by mass or less, and the content of the phosphate ester-type anionic surfactant is preferably 0.2% by mass or more and 2% by mass or less and more preferably 0.5% by mass or more and 1.5% by mass or less.

### Content a of Aromatic Alcohol and Content B of Compatibilizer

The ratio (A/(A+B)) of the content A to the total amount of the content A of the aromatic alcohol and the content B of the compatibilizer satisfies formula 1 below.

$$X \geq 0. 6 \qquad Formula 1$$

In the formula 1, X represents the ratio (A/(A+B)) of the content A to the total amount of the content A of the aromatic alcohol and the content B of the compatibilizer.

From the viewpoint of satisfactorily peeling the urethane resin layer, the ratio (A/(A+B)) is preferably 0.6 or more and 0.8 or less and more preferably 0.7 or more and 0.8 or less.

### [Method for Producing Recycled Aluminum Substrate]

The peeling liquid composition according to the exemplary embodiment of the present disclosure is used in a method for producing a recycled aluminum substrate.

That is, a recycled aluminum substrate may be produced by dipping a metal-resin composite including an aluminum substrate and a urethane resin layer in contact with the surface of the aluminum substrate in the peeling liquid composition according to the exemplary embodiment of the present disclosure, peeling the urethane resin layer from the aluminum substrate.

In addition, the peeling liquid composition may be irradiated with ultrasonic waves during dipping.

A metal-resin composite including an aluminum substrate and a urethane resin layer in contact with the surface of the aluminum substrate is, for example, a photoreceptor used in an electrophotographic image forming apparatus.

The exemplary embodiment is described above, but interpretation is not limited to the exemplary embodiment described above, and various modifications, changes, and improvements can be made.

### EXAMPLES

Examples of the present disclosure are described below, but the present disclosure is not limited to the examples below. In description below, all “parts” and “%” are on mass basis unless otherwise specified.

### Examples and Comparative Examples

### —Preparation of Peeling Liquid Composition—

The components of types described in Table 1 to Table 4 are prepared as an aromatic alcohol, a compatibilizer, an alkanolamine, water, and an anionic surfactant and mixed at the contents described in Table 1 to Table 4, preparing a peeling liquid composition of each of examples and comparative examples.

Regarding the resultant peeling liquid compositions, the calculation results of X (that is, the ratio (A/(A+B))) represented by the formula 1 and (−1.80×X²+1.05×X+0.72)×100 represented by the formula 2 are shown in Table 1 to Table 4.

Components described in Table 1 to Table 4
(Aromatic alcohol)
   Benzyl alcohol
   2-Pyridinemethanol
(Compatibilizer)
   Sodium 2,4-dimethylbenzenesulfonate
   Ethylene glycol diethyl ether
   Sodium 3,5-dimethylbenzenesulfonate
(Alkanolamine)
   Diethanolamine
   Isopropanolamine
   Polyetheramine
(Surfactant)
   Succinic acid-type anionic surfactant (Sanhibitor OMA-10, manufactured by Sanyo Chemical Industries, Ltd.)
   Phosphate ester-type anionic surfactant (Chemistat 3500, manufactured by Sanyo Chemical Industries, Ltd.)
   Fatty acid ester (Ionet DO-1000, manufactured by Sanyo Chemical Industries, Ltd.)

### [Evaluation Test]

### (Mixability)

The mixed peeling liquid composition is evaluated according to criteria below.
A: The peeling liquid composition is not separated (transparent).
B: The peeling liquid composition is not separated (clouded).
C: The peeling liquid composition is kept in a clouded state for a predetermined time after shaking.
D: The peeling liquid composition is separated immediately even after shaking.

### (Peelability)

A test piece (metal-resin composite) including a urethane resin layer provided in contact with the surface of an aluminum substrate is dipped in the peeling liquid composition of each of the examples and the comparative examples and irradiated with ultrasonic waves in the peeling liquid composition. A peeling test is performed under the ultrasonic irradiation conditions including a liquid temperature of 70° C., a frequency of 45 kHz, and an irradiation time (dipping time) of 60 minutes. The test piece after the peeling test is evaluated according to criteria below.
A: The urethane resin layer is peeled at a rate of 100% by area.
B: The urethane resin layer is peeled at a rate of 90% by area or more and less than 100% by area.
C: The urethane resin layer is peeled at a rate of 70% by area or more and less than 90% by area.
D: The urethane resin layer is peeled at a rate of less than 70% by area.

### (Metal Surface: White Pitting Corrosion)

The number of white points (white pitting corrosion) per area of the surface of the aluminum substrate after the (peelability) test is visually confirmed, and evaluated according to criteria below.
A: The number is 5/mm² or less.
B: The number is over 5/mm² and 10/mm² or less.
C: The number is over 10/mm² and 20/mm² or less.
D: The number is over 20/mm².
The number cannot be evaluated because the film is not peeled.

### (Metal Surface: Blackening)

The glossiness of the surface of the aluminum substrate after the (peelability) test is measured by a spectrophotometer and evaluated according to criteria below assuming that the brightness of the unused aluminum substrate is 100%.
A: 95% or more
B: 90% or more and less than 95%
C: 80% or more and less than 90%
D: Less than 80%
The glossiness cannot be evaluated because the film is not peeled.

### (Flash Point)

The flash point of the peeling liquid composition is measured according to JIS K2265-1:2007 (tag-closed type) and JIS K2265-4:2007 (cleveland-open type) and evaluated according to criteria below.
A: No flash point is measured in the tag-closed type test.
B: The flash point of 80° C. or more is measured in the tag-closed type test, and no flash point is measured in the cleveland-open type test.
C: The flash point of 80° C. or more is measured in the tag-closed type test, and the flash point of 60° C. or more is measured in the cleveland-open type test.
D: The flash point of less than 80° C. is measured in the tag-closed type test.

TABLE 1

| | | | | | Formula 1 | | | | |
|---|---|---|---|---|---|---|---|---|---|
| | Aromatic alcohol | | Compatibilizer | | Ratio | Alkanolamine | | Water | |
| | | Content | | Content | (A/(A + B)) | | Content | Content | |
| | | A % by | | B % by | composition | | % by | C % by | Formula |
| | Type | mass | Type | mass | ratio X | Type | mass | mass | 2 |
| Example | Benzyl | 48 | Sodium 2,4- | 13 | 0.79 | Diethanolamine | 3 | 30 | 43 |
| 1 | alcohol | | dimethylbenzenesulfonate | | | | | | |
| Example | Benzyl | 49 | Sodium 2,4- | 13 | 0.79 | Diethanolamine | 3 | 30 | 43 |
| 2 | alcohol | | dimethylbenzenesulfonate | | | | | | |
| Example | Benzyl | 48 | Sodium 2,4- | 13 | 0.79 | Isopropanolamine | 3 | 30 | 43 |
| 3 | alcohol | | dimethylbenzenesulfonate | | | | | | |
| Example | Benzyl | 56 | Sodium 2,4- | 15 | 0.79 | Diethanolamine | 3 | 20 | 43 |
| 4 | alcohol | | dimethylbenzenesulfonate | | | | | | |
| Example | Benzyl | 40 | Sodium 2,4- | 11 | 0.78 | Diethanolamine | 3 | 40 | 44 |
| 5 | alcohol | | dimethylbenzenesulfonate | | | | | | |
| Example | Benzyl | 44 | Sodium 2,4- | 27 | 0.62 | Diethanolamine | 3 | 20 | 68 |
| 6 | alcohol | | dimethylbenzenesulfonate | | | | | | |
| Example | Benzyl | 32 | Sodium 2,4- | 19 | 0.63 | Diethanolamine | 3 | 40 | 67 |
| 7 | alcohol | | dimethylbenzenesulfonate | | | | | | |
| Example | Benzyl | 46 | Sodium 2,4- | 13 | 0.78 | Diethanolamine | 5 | 30 | 44 |
| 8 | alcohol | | dimethylbenzenesulfonate | | | | | | |
| Example | Benzyl | 49 | Sodium 2,4- | 14 | 0.78 | Diethanolamine | 1 | 30 | 45 |
| 9 | alcohol | | dimethylbenzenesulfonate | | | | | | |
| Example | Benzyl | 50 | Sodium 2,4- | 14 | 0.78 | Diethanolamine | 3 | 30 | 44 |
| 10 | alcohol | | dimethylbenzenesulfonate | | | | | | |
| Example | Benzyl | 46 | Sodium 2,4- | 12 | 0.79 | Diethanolamine | 3 | 30 | 42 |
| 11 | alcohol | | dimethylbenzenesulfonate | | | | | | |
| Example | Benzyl | 48.5 | Sodium 2,4- | 13 | 0.79 | Diethanolamine | 3 | 30 | 43 |
| 12 | alcohol | | dimethylbenzenesulfonate | | | | | | |
| Example | Benzyl | 47.5 | Sodium 2,4- | 13 | 0.79 | Diethanolamine | 3 | 30 | 43 |
| 13 | alcohol | | dimethylbenzenesulfonate | | | | | | |
| Example | Benzyl | 61 | Sodium 2,4- | 10 | 0.86 | Diethanolamine | 3 | 20 | 29 |
| 14 | alcohol | | dimethylbenzenesulfonate | | | | | | |

TABLE 2

| | | | | | Evaluation | | | | |
|---|---|---|---|---|---|---|---|---|---|
| | | | | | | | Metal | | |
| | Anionic surfactant | | | | | | surface | | |
| | | Content | | Content | | | white | Metal | |
| | | % by | | % by | | | pitting | surface | Flash |
| | Type | mass | Type | mass | Mixability | Peelability | corrosion | blackening | point |
| Example 1 | Succinic | 5 | Phosphate | 1 | A | A | A | A | B |
| | acid-type | | ester-type | | | | | | |
| | anionic | | anionic | | | | | | |
| | surfactant | | surfactant | | | | | | |
| Example 2 | Succinic | 5 | — | | A | A | A | C | B |
| | acid-type | | | | | | | | |
| | anionic | | | | | | | | |
| | surfactant | | | | | | | | |
| Example 3 | Succinic | 5 | Phosphate | 1 | A | A | A | A | B |
| | acid-type | | ester-type | | | | | | |
| | anionic | | anionic | | | | | | |
| | surfactant | | surfactant | | | | | | |
| Example 4 | Succinic | 5 | Phosphate | 1 | A | A | A | B | C |
| | acid-type | | ester-type | | | | | | |
| | anionic | | anionic | | | | | | |
| | surfactant | | surfactant | | | | | | |
| Example 5 | Succinic | 5 | Phosphate | 1 | A | B | B | A | A |
| | acid-type | | ester-type | | | | | | |
| | anionic | | anionic | | | | | | |
| | surfactant | | surfactant | | | | | | |
| Example 6 | Succinic | 5 | Phosphate | 1 | A | B | A | B | C |
| | acid-type | | ester-type | | | | | | |
| | anionic | | anionic | | | | | | |
| | surfactant | | surfactant | | | | | | |
| Example 7 | Succinic | 5 | Phosphate | 1 | A | C | B | A | A |
| | acid-type | | ester-type | | | | | | |
| | anionic | | anionic | | | | | | |
| | surfactant | | surfactant | | | | | | |
| Example 8 | Succinic | 5 | Phosphate | 1 | A | A | C | B | B |
| | acid-type | | ester-type | | | | | | |
| | anionic | | anionic | | | | | | |
| | surfactant | | surfactant | | | | | | |
| Example 9 | Succinic | 5 | Phosphate | 1 | A | C | A | A | B |
| | acid-type | | ester-type | | | | | | |
| | anionic | | anionic | | | | | | |
| | surfactant | | surfactant | | | | | | |
| Example 10 | Succinic | 2 | Phosphate | 1 | A | A | C | B | B |
| | acid-type | | ester-type | | | | | | |
| | anionic | | anionic | | | | | | |
| | surfactant | | surfactant | | | | | | |
| Example 11 | Succinic | 8 | Phosphate | 1 | A | A | C | B | B |
| | acid-type | | ester-type | | | | | | |
| | anionic | | anionic | | | | | | |
| | surfactant | | surfactant | | | | | | |
| Example 12 | Succinic | 5 | Phosphate | 0.5 | A | A | B | C | B |
| | acid-type | | ester-type | | | | | | |
| | anionic | | anionic | | | | | | |
| | surfactant | | surfactant | | | | | | |
| Example 13 | Succinic | 5 | Phosphate | 1.5 | A | A | B | A | B |
| | acid-type | | ester-type | | | | | | |
| | anionic | | anionic | | | | | | |
| | surfactant | | surfactant | | | | | | |
| Example 14 | Succinic | 5 | Phosphate | 1 | C | A | A | C | C |
| | acid-type | | ester-type | | | | | | |
| | anionic | | anionic | | | | | | |
| | surfactant | | surfactant | | | | | | |

TABLE 3

| | | | | | Formula 1 | | | | |
|---|---|---|---|---|---|---|---|---|---|
| | Aromatic alcohol | | Compatibilizer | | Ratio | Alkanolamine | | Water | |
| | | Content | | Content | (A/(A + B)) | | Content | Content | |
| | | A % by | | B % by | composition | | % by | C % by | Formula |
| | Type | mass | Type | mass | ratio X | Type | mass | mass | 2 |
| Example 15 | Benzyl alcohol | 64 | Sodium 2,4- | 17 | 0.79 | Diethanolamine | 3 | 10 | 43 |
| | | | dimethylbenzenesulfonate | | | | | | |
| Example 16 | Benzyl alcohol | 50 | Sodium 2,4- | 31 | 0.62 | Diethanolamine | 3 | 10 | 68 |
| | | | dimethylbenzenesulfonate | | | | | | |
| Example 17 | 2-Pyridinemethanol | 48 | Sodium 2,4- | 13 | 0.79 | Diethanolamine | 3 | 30 | 43 |
| | | | dimethylbenzenesulfonate | | | | | | |
| Example 18 | Benzyl alcohol | 51 | Ethylene glycol | 8 | 0.86 | Diethanolamine | 3 | 32 | 28 |
| | | | diethyl ether | | | | | | |
| Example 19 | Benzyl alcohol | 48 | Sodium 2,4- | 13 | 0.79 | Polyetheramine | 3 | 30 | 43 |
| | | | dimethylbenzenesulfonate | | | | | | |
| Example 20 | 2-Pyridinemethanol | 51 | Ethylene glycol | 8 | 0.86 | Polyetheramine | 3 | 32 | 28 |
| | | | diethyl ether | | | | | | |
| Comparative | Benzyl alcohol | 53 | Sodium 2,4- | 8 | 0.87 | Diethanolamine | 3 | 30 | 27 |
| Example 1 | | | dimethylbenzenesulfonate | | | | | | |
| Comparative | Benzyl alcohol | 44 | Sodium 2,4- | 7 | 0.86 | Diethanolamine | 3 | 40 | 29 |
| Example 2 | | | dimethylbenzenesulfonate | | | | | | |
| Comparative | Benzyl alcohol | 36 | Sodium 2,4 | 25 | 0.59 | Diethanolamine | 3 | 30 | 71 |
| Example 3 | | | dimethylbenzenesulfonate | | | | | | |
| Comparative | Benzyl alcohol | 41 | Sodium 2,4- | 30 | 0.58 | Diethanolamine | 3 | 20 | 73 |
| Example 4 | | | dimethylbenzenesulfonate | | | | | | |
| Comparative | Benzyl alcohol | 32 | Sodium 2,4- | 9 | 0.78 | Diethanolamine | 3 | 50 | 44 |
| Example 5 | | | dimethylbenzenesulfonate | | | | | | |
| Comparative | Benzyl alcohol | 50 | Sodium 2,4- | 14 | 0.78 | — | | 30 | 44 |
| Example 6 | | | dimethylbenzenesulfonate | | | | | | |
| Comparative | Benzyl alcohol | 52 | Sodium 3,5- | 15 | 0.78 | Diethanolamine | 3 | 30 | 45 |
| Example 7 | | | dimethylbenzenesulfonate | | | | | | |
| Comparative | Benzyl alcohol | 49 | Sodium 3,5- | 13 | 0.79 | Diethanolamine | 3 | 30 | 43 |
| Example 8 | | | dimethylbenzenesulfonate | | | | | | |

TABLE 4

| | | | | | Evaluation | | | | |
|---|---|---|---|---|---|---|---|---|---|
| | Anionic surfactant | | | | | | Metal surface | | |
| | | Content | | Content | | | white | Metal | |
| | | % by | | % by | | | pitting | surface | Flash |
| | Type | mass | Type | mass | Mixability | Peelability | corrosion | blackening | point |
| Example 15 | Succinic | 5 | Phosphate | 1 | A | A | A | C | C |
| | acid-type | | ester-type | | | | | | |
| | anionic | | anionic | | | | | | |
| | surfactant | | surfactant | | | | | | |
| Example 16 | Succinic | 5 | Phosphate | 1 | A | B | B | C | C |
| | acid-type | | ester-type | | | | | | |
| | anionic | | anionic | | | | | | |
| | surfactant | | surfactant | | | | | | |
| Example 17 | Succinic | 5 | Phosphate | 1 | B | C | A | A | B |
| | acid-type | | ester-type | | | | | | |
| | anionic | | anionic | | | | | | |
| | surfactant | | surfactant | | | | | | |
| Example 18 | Succinic | 5 | Phosphate | 1 | C | B | A | B | B |
| | acid-type | | ester-type | | | | | | |
| | anionic | | anionic | | | | | | |
| | surfactant | | surfactant | | | | | | |
| Example 19 | Succinic | 5 | Phosphate | 1 | A | C | B | A | B |
| | acid-type | | ester-type | | | | | | |
| | anionic | | anionic | | | | | | |
| | surfactant | | surfactant | | | | | | |
| Example 20 | Succinic | 5 | Phosphate | 1 | C | C | B | A | B |
| | acid-type | | ester-type | | | | | | |
| | anionic | | anionic | | | | | | |
| | surfactant | | surfactant | | | | | | |
| Comparative | Succinic | 5 | Phosphate | 1 | D | A | B | B | B |
| Example 1 | acid-type | | ester-type | | | | | | |
| | anionic | | anionic | | | | | | |
| | surfactant | | surfactant | | | | | | |
| Comparative | Succinic | 5 | Phosphate | 1 | D | B | B | B | A |
| Example 2 | acid-type | | ester-type | | | | | | |
| | anionic | | anionic | | | | | | |
| | surfactant | | surfactant | | | | | | |
| Comparative | Succinic | 5 | Phosphate | 1 | A | D | — | — | B |
| Example 3 | acid-type | | ester-type | | | | | | |
| | anionic | | anionic | | | | | | |
| | surfactant | | surfactant | | | | | | |
| Comparative | Succinic | 5 | Phosphate | 1 | A | D | — | — | C |
| Example 4 | acid-type | | ester-type | | | | | | |
| | anionic | | anionic | | | | | | |
| | surfactant | | surfactant | | | | | | |
| Comparative | Succinic | 5 | Phosphate | 1 | D | C | B | B | A |
| Example 5 | acid-type | | ester-type | | | | | | |
| | anionic | | anionic | | | | | | |
| | surfactant | | surfactant | | | | | | |
| Comparative | Succinic | 5 | Phosphate | 1 | A | D | — | — | B |
| Example 6 | acid-type | | ester-type | | | | | | |
| | anionic | | anionic | | | | | | |
| | surfactant | | surfactant | | | | | | |
| Comparative | — | | — | | A | A | D | C | B |
| Example 7 | | | | | | | | | |
| Comparative | Fatty acid | 5 | — | | A | A | D | C | B |
| Example 8 | ester lonet | | | | | | | | |
| | DO-1000 | | | | | | | | |

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

A peeling liquid composition including an aromatic alcohol, a compatibilizer, water, an alkanolamine, and an anionic surfactant,
in which the content A of the aromatic alcohol, the content B of the compatibilizer, and the content C of water satisfy formula 1 and formula 2 below:

$$X \geq 0. 6 \qquad Formula 1$$

$$C \leq ( - 1.80 \times {X}^{2} + 1.05 \times X + 0.72 ) \times 100 \qquad Formula 2$$

in the formula 1 and formula 2, X represents the ratio (A/(A+B)) of the content A to the total of the content A of the aromatic alcohol and the content B of the compatibilizer.
   (((2)))

The peeling liquid composition described in (((1))), in which the ratio (A/(A+B)) of the content A to the total of the content A of the aromatic alcohol and the content B of the compatibilizer is 0.6 or more and 0.8 or less.

(((3)))

The peeling liquid composition described in (((2)), in which the ratio (A/(A+B)) of the content A to the total of the content A of the aromatic alcohol and the content B of the compatibilizer is 0.7 or more and 0.8 or less.

(((4)))

The peeling liquid composition described in any one of (((1))) to (((3))), in which the content of water is 15% by mass or more and 35% by mass or less.

(((5)))

The peeling liquid composition described in (((4))), in which the content of water is 20% by mass or more and 30% by mass or less.

(((6)))

The peeling liquid composition described in any one of (((1))) to (((5))), in which the content of the aromatic alcohol is 35% by mass or more and 60% by mass or less.

(((7)))

The peeling liquid composition described in any one of (((1))) to (((6))), in which the aromatic alcohol is at least one selected from the group consisting of benzyl alcohol, 2-phenylethanol, 2-aminobenzyl alcohol, 3-aminobenzyl alcohol, and 2,3-dimethoxybenzyl alcohol.

(((8)))

The peeling liquid composition described in (((7))), in which the aromatic alcohol is benzyl alcohol.

(((9)))

The peeling liquid composition described in any one of (((1))) to (((8))), in which the compatibilizer is sodium benzenesulfonate.

(((10)))

The peeling liquid composition described in (((9))), in which the sodium benzenesulfonate is at least one selected from the group consisting of sodium 2,4-dimethylbenzenesulfonate, sodium 3,5-dimethylbenzenesulfonate, sodium 4-dodecylbenzenesulfonate, sodium cumenesulfonate, and sodium o-formylbenzenesulfonate.

(((11)))

The peeling liquid composition described in (((10))), in which the sodium benzenesulfonate is sodium 2,4-dimethylbenzenesulfonate.

(((12)))

The peeling liquid composition described in any one of (((1))) to (((11))), in which the alkanolamine is at least one selected from the group consisting of ethanolamine, diethanolamine, triethanolamine, isopropanolamine, triisopropanolamine, aminoethylethanolamine, 2-amino-2-methyl-1-propanol, diglycolamine, and N-methyl-2-pyrrolidone.

(((13)))

The peeling liquid composition described in (((12))), in which the alkanolamine is at least one selected from the group consisting of diethanolamine and isopropanolamine.

(((14)))

The peeling liquid composition described in any one of (((1))) to (((13))), in which a succinic acid-type anionic surfactant and a phosphate ester-type anionic surfactant are contained in the anionic surfactant.

(((15)))

A method for producing a recycled aluminum substrate including dipping a metal-resin composite having an aluminum substrate and a urethane resin layer in contact with the surface of the aluminum substrate in the peeling liquid composition described in any one of (((1))) to (((14))) to peel the urethane resin layer from the aluminum substrate, producing a recycled aluminum substrate.

What is claimed is:

1. A peeling liquid composition comprising:
an aromatic alcohol, a compatibilizer, water, an alkanolamine, and an anionic surfactant,
wherein the content A of the aromatic alcohol, the content B of the compatibilizer, and the content C of water satisfy formula 1 and formula 2 below:
$$X \geq 0. 6 \qquad Formula 1$$
$$C \leq ( - 1.80 \times {X}^{2} + 1.05 \times X + 0.72 ) \times 100 \qquad Formula 2$$
in the formula 1 and formula 2, X represents the ratio (A/(A+B)) of the content A to the total of the content A of the aromatic alcohol and the content B of the compatibilizer.

2. The peeling liquid composition according to claim 1, wherein the ratio (A/(A+B)) of the content A to the total of the content A of the aromatic alcohol and the content B of the compatibilizer is 0.6 or more and 0.8 or less.

3. The peeling liquid composition according to claim 2, wherein the ratio (A/(A+B)) of the content A to the total of the content A of the aromatic alcohol and the content B of the compatibilizer is 0.7 or more and 0.8 or less.

4. The peeling liquid composition according to claim 1, wherein the content of water is 15% by mass or more and 35% by mass or less.

5. The peeling liquid composition according to claim 4, wherein the content of water is 20% by mass or more and 30% by mass or less.

6. The peeling liquid composition according to claim 1, wherein the content of the aromatic alcohol is 35% by mass or more and 60% by mass or less.

7. The peeling liquid composition according to claim 1, wherein the aromatic alcohol is at least one selected from the group consisting of benzyl alcohol, 2-phenylethanol, 2-aminobenzyl alcohol, 3-aminobenzyl alcohol, and 2,3-dimethoxybenzyl alcohol.

8. The peeling liquid composition according to claim 7, wherein the aromatic alcohol is benzyl alcohol.

9. The peeling liquid composition according to claim 1, wherein the compatibilizer is sodium benzenesulfonate.

10. The peeling liquid composition according to claim 9, wherein the sodium benzenesulfonate is at least one selected from the group consisting of sodium 2,4-dimethylbenzenesulfonate, sodium 3,5-dimethylbenzenesulfonate, sodium 4-dodecylbenzenesulfonate, sodium cumenesulfonate, and sodium o-formylbenzenesulfonate.

11. The peeling liquid composition according to claim 10, wherein the sodium benzenesulfonate is sodium 2,4-dimethylbenzenesulfonate.

12. The peeling liquid composition according to claim 1, wherein the alkanolamine is at least one selected from the group consisting of ethanolamine, diethanolamine, triethanolamine, isopropanolamine, triisopropanolamine, aminoethylethanolamine, 2-amino-2-methyl-1-propanol, diglycolamine, and N-methyl-2-pyrrolidone.

13. The peeling liquid composition according to claim 12, wherein the alkanolamine is at least one selected from the group consisting of diethanolamine and isopropanolamine.

14. The peeling liquid composition according to claim 1, wherein a succinic acid-type anionic surfactant and a phosphate ester-type anionic surfactant are contained as the anionic surfactant.

15. A method for producing a recycled aluminum substrate comprising:
dipping a metal-resin composite having an aluminum substrate and a urethane resin layer in contact with the surface of the aluminum substrate in the peeling liquid composition according to claim 1 to peel the urethane resin layer from the aluminum substrate, producing a recycled aluminum substrate.
